(19) United States
(12) Patent Application Publication
(10) Pub. No.: US 2021/0102781 A1
(43) Pub. Date: Apr. 8, 2021

(54) POINT-OF-IMPACT ANALYSIS APPARATUS FOR IMPROVING ACCURACY OF BALLISTIC TRAJECTORY AND POINT OF IMPACT BY APPLYING SHOOTING ENVIRONMENT OF REAL PERSONAL FIREARM TO VIRTUAL REALITY, AND VIRTUAL SHOOTING TRAINING SIMULATION USING SAME

(71) Applicants: KOREA MILITARY ACADEMY R&DB FOUNDATION, Nowon-gu (KR); OPTIMUS SYSTEM CO., LTD., Yongin-si, Gyeonggi-do (KR)

(72) Inventors: Byoung Hwak LEE, Seoul (KR); Suk Bong PARK, Seoul (KR); Won Woo LEE, Seoul (KR); Dong Wook KIM, Seoul (KR); Kyu Yong SHIN, Seoul (KR); Ju Hee KIM, Seoul (KR); Young Jun PARK, Seoul (KR); Hyun Ho CHOI, Seoul (KR); Jong Hwan KIM, Seoul (KR); Won Seok KANG, Seoul (KR); Yun Ki GWAK, Yeongtong-gu, Suwon-shi, Gyeonggi-do (KR); Hong Cheol CHOI, Seoul (KR); Nam Hyuk KIM, Gyeonggi-do (KR)

(21) Appl. No.: 17/041,009

(22) PCT Filed: Nov. 26, 2018
(86) PCT No.: PCT/KR2018/014647

§ 371 Date: Sep. 24, 2020

(30) Foreign Application Priority Data
Mar. 26, 2018 (KR) 10-2018-0034594
Oct. 29, 2018 (KR) 10-2018-0130030

(51) Int. Cl. F41G 3/26; G06T 7/70

(52) U.S. Cl. CPC F41G 3/26; G06T 2207/30241; G06T 7/70

(57) ABSTRACT

The present invention relates to a point-of-impact analysis apparatus for improving the accuracy of a ballistic trajectory and a point of impact by applying a shooting environment of a real personal firearm to virtual reality, and a virtual shooting training simulation system using same, the point-of-impact analysis apparatus including: a gun analysis module for generating gun information on a gun structure of a virtual gun which is a model possessed by a user in a real space; a bullet analysis module for generating bullet information on a structure of a bullet applied to the virtual gun; an environment analysis module for detecting an environmental state of a shooting training content output on a screen so as to generate environmental information on the environmental state; and a point-of-impact generation module for generating point-of-impact information related to a position, at which the bullet impacts a target displayed on the screen, by making reference to at least one piece of information among the gun information, the bullet information, and the environmental information.

### TECHNICAL FIELD

The present invention relates to an apparatus capable of calculating the same ballistic trajectory and point of impact as a real environment by applying a shooting environment of a real personal firearm to shooting training in virtual reality, and a shooting training simulation system using the same.

### BACKGROUND ART

In general, shooting training may be conducted by firing a live ammunition at an object with an actual gun and evaluating whether or not the live ammunition hits the object.

However, such actual shooting training has many restrictions due to the management problem of a gun, the danger of live shooting training, the difficulty in setting up a training place, and the like. In particular, it is a reality that even in special groups such as armed forces operating the live ammunition have restrictions in the frequency of training or training methods due to the problem of bullet shell management and operational costs.

In order to solve this problem, a virtual shooting training simulation in which shooting training is performed in virtual reality has been developed and used recently.

In the virtual shooting training simulation, when a user performs a simulated trigger on an object output on a screen with a virtual gun, a hit is made to the object according to the corresponding trigger direction. Therefore, since equipment and shooting places such as the actual gun and the live ammunition are not required, there may be no restrictions in the danger, frequency, and place of training.

However, the virtual shooting training simulation may have a sense of difference from actual shooting training as it is virtually made by an electronic process.

In particular, a ballistic trajectory of the virtual shooting training simulation and the corresponding point of impact have differently been applied from the actual shooting training. In other words, the virtual shooting training simulation currently in operation assumes that a center of mass of a bullet fired from the virtual gun is a simple translational motion. In other words, in the virtual shooting, as the ballistic trajectory and the point of impact are formed under the assumption that the bullet is not affected by various laws of motion and environment, there is a difference from the ballistic trajectory and the point of impact generated in the actual shooting training.

When the discrepancy between the ballistic trajectory and the corresponding point of impact occurs, there is a problem in that the efficiency of the shooting training suddenly deteriorates and the result of the virtual shooting training is not reflected in the actual battle, and thus a countermeasure to the problem is required.

### DISCLOSURE

### Technical Problem

An object of the present invention is to provide a point-of-impact analysis apparatus for improving accuracy of a ballistic trajectory and a point of impact by applying a shooting environment of a real personal firearm in virtual reality that can further improve the reality of the ballistic trajectory and the point of impact generated in virtual shooting by reflecting a type of guns and bullets and environmental factors, and a virtual shooting training simulation system using the same.

[National R&D Project Supporting The Invention]

[Unique Project Number] 2017-0-01783

[Ministry Name] Ministry of Science and ICT

[Institution Specialized in Research Management] Information and Communication Technology Promotion Center

[Research Business Name] Digital Contents (VA/AR/MR) Flagship Project in 2017

[Research Project Name] Virtual Reality-based Practical Integrated Combat Training System Construction

[Contribution Rate] 1/1

[Responsible Agency] Military Academy Industry-Academic Cooperation Group

[Research Period] Jul. 1, 2017 to Dec. 31, 2018

### Technical Solution

In one general aspect, there is provided a point-of-impact analysis apparatus for improving accuracy of a ballistic trajectory and a point of impact by applying shooting environment of a real personal firearm in virtual reality, the point-of-impact analysis apparatus, including: a gun analysis module for generating gun information on a gun structure of a virtual gun which is a model possessed by a user in a real space; a bullet analysis module for generating bullet information on a structure of a bullet applied to the virtual gun; an environment analysis module for detecting an environmental state of a shooting training content output on a screen so as to generate environmental information on the environmental state; and a point-of-impact generation module for generating point-of-impact information related to a position, at which the bullet impacts a target displayed on a screen, by making reference to at least one piece of information among the gun information, the bullet information, and the environmental information.

The gun information may include gun type information, gunbarrel length information, and gun stiffness information, and the bullet information may include bullet type information, bullet mass information, bullet appearance information, and bullet pressure center information.

The point-of-impact generation module may generate first bullet movement information related to movement information on the bullet in the virtual gun by referring to the gun information and the bullet information.

In another general aspect, there is provided a virtual shooting training simulation system for image correction reflecting a real space and improvement in accuracy of a point of impact, the virtual shooting training simulation system including: an image detection apparatus for generating object image information, which is image information, by detecting a user and a virtual gun, which is a model possessed by the user, based on a screen on which shooting training content is output in a real space; an image correction apparatus for comparing reference image information detected at a reference position by analyzing the object image information and change image information detected at a change position, which is a position changed from the reference position, to generate correction information as a result value thereof, and for generating correction image information in which the correction information is reflected in the change image information; and a point-of-impact analysis apparatus for generating point-of-impact information on a position at which the bullet impacts a target displayed on the screen by referring to gun information on a structure of the virtual gun, bullet information on a structure of a bullet applied to the virtual gun, and environmental information on an environmental state of the shooting training content.

The image correction apparatus may include: a reference image module for generating the reference image information which is an image corresponding to the reference position information when the position information of the user and the virtual gun, which is an object of the screen detected in the real space, includes reference position information that is a preset reference position; a change image module for generating change image information which is an image corresponding to the change position information when the reference position changes to a change position by the movement of the object and the position information therefor is detected; and a correction module for comparing the reference position information and the change position information to generate the correction information as a result value therefor and generating correction image information in which the correction information is reflected in the change image information.

Here, the reference position information may be generated by referring to screen coordinate information that is a coordinate value of the screen, reference coordinate information which is a coordinate value for a reference position in the real space initially set by the image detection apparatus, and a positional relationship with the screen coordinate information at a measurement position of the measurement apparatus disposed in the real space.

The screen coordinate information may include screen reference coordinate information corresponding to the circumferential area of the screen and screen temporary coordinate information regarding a plurality of coordinates spaced apart from each other in an inner area of the screen, the measurement apparatus may generate measurement/screen position information on a positional relationship with the screen temporary coordination information at the measurement position when input information corresponding to the screen temporary coordinate information is input and generate measurement/reference position information on the positional relationship with the reference coordinate information at the measurement position to transmit the generated measurement/screen position information and the measurement/reference position information, respectively, to the reference image module, the reference image module may match the measurement/screen position information with the screen reference coordinate information to generate first reference relation information on a correlation thereof, refer to the measurement/screen position information and the measurement/reference position information to generate a second reference relation information on a correlation thereof, and refer to the first reference relation information and the second reference relation information to generate third reference relation information on a correlation of the measurement/reference position information and the screen reference coordinate information.

### BRIEF DESCRIPTION OF THE DRAWINGS

FIG. 1 is a conceptual diagram for explaining a method of operating a point-of-impact analysis apparatus 100 according to an embodiment of the present invention.

FIG. 2 is a block diagram for explaining a module configuration of the point-of-impact analysis apparatus 100 according to the embodiment of the present invention.

FIG. 3 is a view for explaining a gunbarrel length of a virtual gun F according to an embodiment of the present invention.

FIG. 4 is a diagram for explaining a type and structure of bullet B according to an embodiment of the present invention.

FIG. 5 is a diagram for explaining environmental information of shooting training content output on a screen S according to an embodiment of the present invention.

FIG. 6 is a diagram for explaining a method of correcting a change in point of impact over a movement time of the bullet B according to the embodiment of the present invention.

FIG. 7 is a diagram for explaining a howitzer moving method of the bullet B according to the embodiment of the present invention.

FIG. 8 is a conceptual diagram for explaining a method of using a virtual shooting training simulation system 10 according to another embodiment of the present invention.

FIG. 9 is a block diagram for explaining a configuration of an image correction apparatus included in the virtual shooting training simulation system 10 of FIG. 8.

FIG. 10 is a flowchart illustrating a method of operating the virtual shooting training simulation system 10 of FIG. 8.

FIGS. 11 to 16 are diagrams for explaining the operation method of FIG. 10 by images for each step.

FIGS. 17 and 18 are diagrams for explaining a method of deriving a ballistic trajectory according to an embodiment of the present invention.

FIG. 19 is a diagram for explaining a point of impact changed according to the ballistic trajectory according to the embodiment of the present invention.

### BEST MODE

Hereinafter, a point-of-impact analysis apparatus for improving accuracy of a ballistic trajectory and a point of impact by applying a shooting environment of a real personal firearm in virtual reality according to a preferred embodiment of the present invention, and a virtual shooting training simulation system using the same will be described in detail with reference to the drawings. Throughout the present disclosure, components that are the same as or similar to each other will be denoted by reference numerals that are the same as or similar to each other and a description therefor will be replaced by the first description, in different exemplary embodiments.

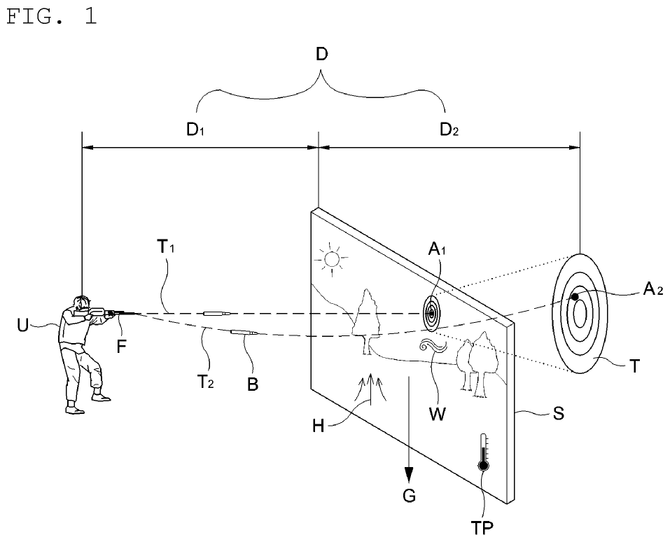

FIG. 1 is a conceptual diagram for explaining a method of operating a point-of-impact analysis apparatus 100 according to an embodiment of the present invention.

As illustrated in FIG. 1, in real space, a user U equipped with a virtual gun F, which is a model gun corresponding to an actual gun, may be positioned with respect to a screen S.

The screen S may output shooting training content which is a program related to shooting training conducted in virtual reality.

The shooting training content may be a shooting training program in the virtual reality in which a target T, which is a target of shooting in various terrains and environments, is selectively positioned, movably created, or disappears. Such shooting training content may be received from an external server, such as a website, or an external terminal through a communication module and stored in a memory module.

A virtual gun F may be a model gun that may be linked to the shooting training content. The virtual gun F may have the same shape as the actual gun, and trigger information may be generated when a trigger is pulled. Accordingly, when position information and direction information of the virtual gun F is received through a vision detection module not illustrated in the present embodiment, the received position information and direction information may be reflected in the shooting training content output on the screen S. In addition, when the trigger information is received from the virtual gun F, the received trigger information may be reflected in the shooting training content by referring to the position information and direction information of the virtual gun F at the time of receiving the corresponding trigger information.

In such a virtual gun F, a member such as a vision marker is attached to a muzzle, a body, or the like, and the vision detection module detects the vision marker to generate information on the position and direction of the virtual gun F. In addition, the vision detection module may detect image information of the virtual gun F in real time, compare the detected image information with reference image information that is a reference value stored in the memory module, and generate the information on the position and direction of the virtual gun F.

The vision detection module may detect a position and direction of the user U through the above-described method and generate information on the detected position and direction.

In the environment thus configured, the point-of-impact analysis apparatus 100 may generate point-of-impact information which is information on a ballistic trajectory and an impact position for a target accordingly by referring to at least one of gun information on a gun structure of the virtual gun F, bullet information on a structure of a bullet B applied to the virtual gun F, and environmental information on an environmental state of the shooting training content.

In the existing shooting training simulation, when the virtual gun F is fired toward the screen S, a portion marked with a laser on the screen S is immediately recognized as a first point of impact Al. In other words, as in the present embodiment, the existing shooting training simulation is designed to exclude factors that actually affect a distance between the virtual gun F and the screen S and a ballistic, and have a first ballistic trajectory T1 formed in a linear line and a first point of impact T1 accordingly.

However, in the actual shooting, the ballistic trajectory and the point of impact change due to the distance between the gun and the target T, the structure of the gun, the structure of the bullet, the shooting environment, and the like. Therefore, in order for the shooting training content to have maximum similarity to the actual shooting training, it is necessary to consider all of the above-described variables.

Therefore, the point-of-impact analysis apparatus 100 of the present embodiment may generate the point-of-impact information in consideration of all of the gun information on the structure of the virtual gun F possessed by the user U, bullet information on the structure of bullet B applied to the virtual gun F, wind direction/wind speed information W, atmospheric pressure information H, gravitational information G, and temperature information TP of the shooting training content output on the screen S, and the like. As a result, unlike the first ballistic trajectory T1, which is a linear ballistic trajectory generated in the existing shooting training simulation, and the first point of impact A1 accordingly, a second ballistic trajectory T2, which is a ballistic trajectory having a curve, and a second point of impact A2 may be calculated. The second ballistic trajectory T2 and the second point of impact A2 according to the present embodiment are illustrated by processing for illustration of description, and the second ballistic trajectory T2 and the second point of impact A2 may be changed according to conditions of various factors.

At this time, the point-of-impact analysis apparatus 100 may generate the point-of-impact information by receiving first bullet movement distance information D1 which is an actual distance from the virtual gun F to the screen S in the real space and second bullet movement distance information D2 which is a virtual distance up to a target T on the shooting training content which is virtual reality displayed on the screen S and applying a combined distance of the first bullet movement distance and the second bullet movement distance as the bullet movement distance information D. In other words, the first bullet movement distance information D1 is the actual distance from the virtual gun F to the screen S in the real space, and the second bullet movement distance information D2 is the virtual distance to the target T on the shooting training content which is virtual reality. Therefore, the bullet movement distance information D may be calculated by reflecting both the distance in the real space and the distance in the virtual space. For example, if the distance in the real space is 2 m and the distance to target T in the virtual space is 5 m, the bullet movement distance information D becomes 7m in total. Accordingly, the point-of-impact analysis apparatus 100 may generate the point-of-impact information by applying the case where the bullet movement distance information D is 7m.

According to this point-of-impact analysis apparatus 100, it is possible to more improve the accuracy and reliability of the point of impact by applying all the information on various factors applied as variables in the actual shooting environment to calculate the ballistic trajectory and the point of impact accordingly.

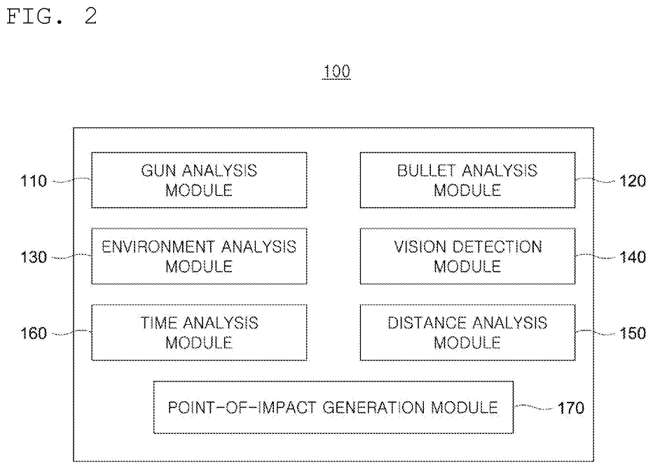

In the above description, the method of operating the point-of-impact analysis apparatus 100 has been briefly described. In FIG. 2, the configurations of the point-of-impact analysis apparatus 100 will be described in detail. According to the point-of-impact analysis apparatus for improving the accuracy of the ballistic trajectory and the point of impact by applying the shooting environment of the real personal firearm in the virtual reality of the present invention configured as described above and the virtual shooting training simulation system using the same, it is possible to generate the point of impact similar to the actual shooting, thereby further improving the training efficiency of the virtual shooting training.

In addition, since a viewpoint of the virtual space is changed as a user's viewpoint in the real space is changed, a degree of matching of a viewpoint between the real space and the virtual space may be further improved.

In addition, when the changed viewpoint deviates from coordinates applied to the existing screen, an image distortion may be minimized by automatically adjusting a screen image ratio to include the corresponding coordinates.

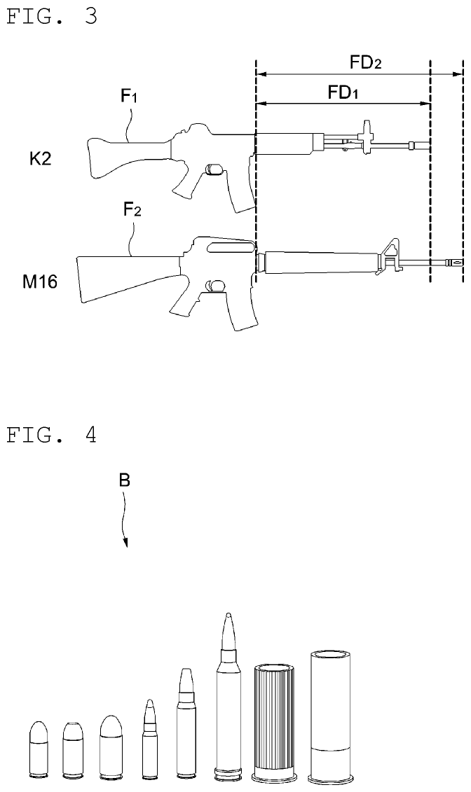

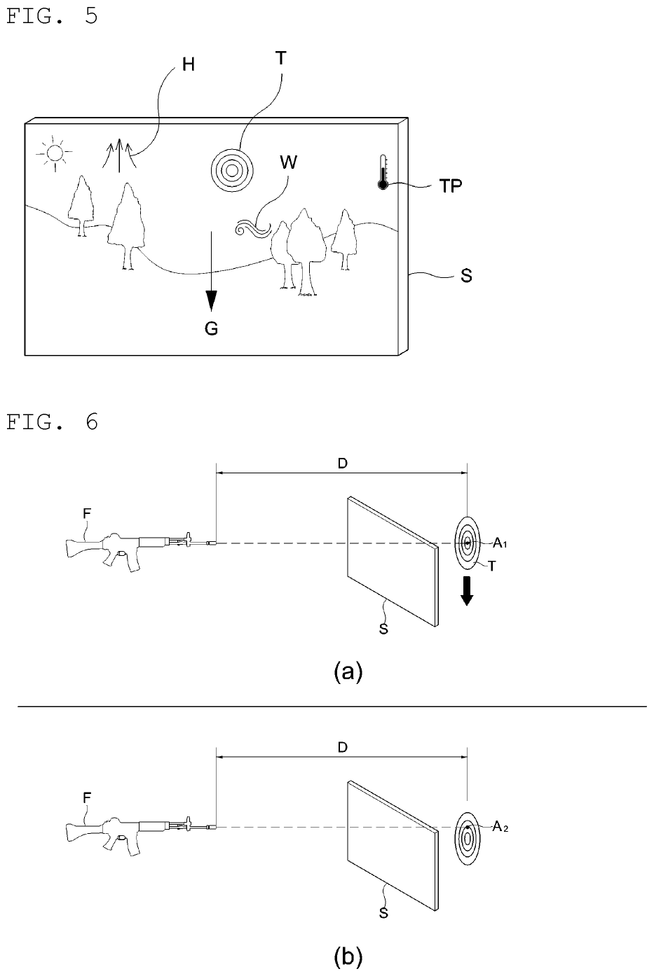

FIG. 2 is a block diagram for explaining a module configuration of the point-of-impact analysis apparatus 100 according to the embodiment of the present invention, FIG. 3 is a gunbarrel length of the virtual gun F according to the embodiment of the present invention, FIG. 4 is a diagram for explaining the type and structure of the bullet B according to the embodiment of the present invention, FIG. 5 is a diagram for explaining environmental information of the shooting training content output on the screen S according to the embodiment of the present invention, and FIG. 6 is a diagram for explaining a method of correcting a change in a point of impact over a movement time of the bullet B according to an embodiment of the present invention.

First, as illustrated in FIG. 2, the point-of-impact analysis apparatus 100 may include a gun analysis module 110, a bullet analysis module 120, an environment analysis module 130, a vision detection module 140, a distance analysis module 150, a time analysis module 160, and a point-of-impact generation module 170.

The gun analysis module 110 may generate the gun information on the gun structure of the virtual gun F, which is a model possessed by the user U in the real space.

The gun information is information on the physical structure of the virtual gun F and may include gun type information, gunbarrel length information, and gun stiffness information. For example, the gun type information may include information on the types of guns on the market such as K2, K1, M16, AK47, K5, and M16A4. At this time, the gun type information may be generated by recognizing the vision marker attached to the virtual gun F, or may be generated by recognizing the image information of the gun through the vision detection module 140 to match the image information with a gun type table stored in a memory module or an external server.

The gunbarrel length information may be length information of a metal tube portion of a fire extinguisher that passes when the bullet B is fired in the virtual gun F as illustrated in FIG. 3. Therefore, the gunbarrel length information may be set differently depending on the gun type. In FIG. 3, when a gunbarrel length F1 of K2 is a first gunbarrel length FD1, a gunbarrel length F2 of M16 may have a second gunbarrel length FD2 that is longer than the first gunbarrel length FD1. Depending on the gunbarrel length, movement information such as a rotation amount of the bullet B is generated differently, and thus may be necessary to be secured.

The gun stiffness information is information on a spiral groove of a bore inside the gunbarrel, and the bullet B rotates along the spiral groove to have a rotational inertia, and therefore may have a stable ballistic. In general, as the bullet B is heavier and longer, more rotations need to be given, so the ballistic may be stabilized. The gun stiffness information may include information on the presence or absence of stiffness, information on a rotation direction of a steel wire, information on the number of steel wires, and the like.

The bullet analysis module 120 may generate the bullet information on the structure of the bullet B, which is a bullet applied to the virtual gun F.

The bullet information may include bullet type information, bullet length information, bullet mass information, bullet appearance information, bullet pressure center information, and the like. In other words, when the gun type information is generated and received, the bullet analysis module 120 may generate the bullet information corresponding to the gun by referring to bullet table information on the bullet B for each gun stored in the memory module or the external server. In this way, the bullet information may be automatically generated, but the bullet information may be input through a user U input module (not illustrated). Manual information input through the user U input module is not limited to the bullet B, but may also be applied to the generation of the gun information.

As illustrated in FIG. 4, the bullet information may include information on shapes of various bullets B, gunpowder embedded in the bullet B, and the like.

As illustrated in FIG. 5, the environment analysis module 130 may detect the environmental state of the shooting training content output on the screen S and generate the environmental information thereon.

The environmental information may include the atmospheric temperature information TP, the density information, the atmospheric pressure information H, the wind direction/wind speed information W, the gravitational information G, and the like for the virtual reality output from the shooting training content. In addition, the environmental information may include climate change information on rain, snow, hail, typhoons, and the like.

Accordingly, the environment analysis module 130 may generate the environmental information on the screen of the shooting training content that is currently output on the screen S and displayed to the user U, so adaptive training for various environmental situations may be performed during actual shooting.

The vision detection module 140 may detect the position and direction of the user U and the virtual gun F, and generate object position information thereon. In other words, the vision detection module 140 may detect the vision marker attached to the user U's body, clothing, or the virtual gun F, or detect the image information of the user U and the virtual gun F, thereby generating the object position information.

The distance analysis module 150 may generate the bullet movement distance information which is a distance that a gun fired from the virtual gun F reaches the target T of the shooting training content.

The bullet movement distance information may include the first bullet movement distance information which is the actual distance that the bullet is moved from the virtual gun F to the screen S in the real space, and the second bullet movement distance information which is the virtual distance to the target T on the shooting training content which is a virtual reality space. In other words, the bullet movement distance information may include the first bullet movement distance information which is the actual distance information from the virtual gun F to the screen S in the real space, and the second bullet movement distance information which is the virtual distance to the target T on the shooting training content which is the virtual space.

To this end, the distance analysis module 150 may generate the first bullet movement distance information by referring to the object position information generated through the vision detection module 140. It is possible to generate the second bullet movement distance information by referring to the shooting training content. By combining the first and second bullet distance movement information thus generated, the bullet movement distance information, which is the total movement distance of the bullet may be generated.

The time analysis module 160 may generate impact time information on a time when the bullet is moved from the virtual gun F to the target T. Typically, the point of impact was formed on the target T at the moment when the virtual gun F is fired toward the screen S, but in the actual shooting, a time delay occurs between the triggering and the impact due to the distance from the target T, various factors, and the like. Therefore, when the target T is moved, the point of impact due to the time delay may be changed.

In other words, since the time delay is not generally considered, even when the target T is moved as illustrated in FIG. 6(a), only the first point of impact Al for the trigger moment of the bullet B may be formed. However, when considering the time delay, the movement distance of the object is changed over the time when the bullet B is moved toward the target T as in FIG. 6(b), and thus the bullet B may be impacted at the second point of impact A2 different from the first point of impact A1.

To this end, the time analysis module 160 may generate the bullet movement distance information through the distance analysis module 150 and the impact time information through the trigger time information on the time when bullet B is fired from the virtual gun F. In addition, the time analysis module 160 may refer to gun information, bullet information, environmental information, and the like and apply the gun information, the bullet information, the environmental information, and the like to the impact time information.

The point-of-impact generation module 170 may generate the point-of-impact information on the position where the bullet B triggered from the virtual gun F is impacted at the target T displayed on the screen S by referring to the information generated by the above-described configurations. In other words, the point-of-impact generation module 170 may generate point-of-impact information obtained by collecting the information on various variables generated by each of the above-described modules and reflecting the collected information.

Specifically, the point-of-impact generation module 170 may generate the first bullet movement information on the movement of the bullet B within the virtual gun F by referring to the gun information and the bullet information.

The first bullet movement information may be interior ballistic information on the movement information until the bullet B starts moving within the virtual gun F in the first stage of the ballistic and leaves the muzzle. To this end, the point-of-impact generation module 170 may generate the first bullet movement information according to Equations 1 and 2 below. Here, the first bullet movement information may be information on kinetic energy of the bullet.

K=½mv²+½IW² [Equation 1]

(K: first bullet movement information, m: bullet weight, v: bullet speed I: inertial moment, ω: bullet rotational angular velocity)

I=∫₀^{R}r²dm [Equation 2]

(dm: fine particle mass, γ: linear length from rotation center axis to fine mass, R: maximum linear length of object from rotation center axis)

Here, the maximum linear length of the object from the rotation center axis may be information on the radius of bullet B.

In other words, the first bullet movement information may include information on acceleration and rotational force generated by a charge and a gun structure when a specific type of bullet B is triggered in the virtual gun F.

In addition, the point-of-impact generation module 170 may generate the second bullet movement information on the movement of the bullet B that is moved between the virtual gun F and the target T output on the screen S by referring to the first bullet movement information and the environmental information.

The second bullet movement information may be exterior ballistic information related to the movement information that is changed by environment (atmospheric pressure, gravity, temperature, wind direction/wind speed) and the like when bullet B is flying in the air. To this end, the point-of-impact generation module 170 may generate the second bullet movement information according to Equation 3 below.

$$second bullet movement information ( {a}_{x} , {a}_{y} ) = ( - \frac{π {C}_{D} {d}^{2}}{8 m} ρ V \frac{dx}{dt} , - \frac{π {C}_{D} {d}^{2}}{8 m} ρ V \frac{dy}{dt} - g ) \qquad [ Equation 3 ]$$

(aₓ: force acting on X axis of bullet, a_{y}: force acting on Y axis of bullet, C_{D}: drag coefficient, p: air density, d: bullet diameter, V: bullet speed in air, g: acceleration of gravity)

In other words, the second bullet movement information may include information on resistance energy acting on the bullet B fired from the virtual gun F to the outside. Therefore, the resistance energy due to the gravity and air density may be the resistance energy acting in the opposite direction to the travel direction of the bullet.

As a result, the first bullet movement information may be information on the kinetic energy of bullet B in the gun, and the second bullet movement information may be information on the kinetic energy at a position where the bullet B is out of the gun.

When the first and second bullet movement information are generated in this way, the point-of-impact generation module 170 may generate the bullet movement distance information, which is the distance from the virtual gun F to the target T, and the point-of-impact information by referring to the position and structure information of the target T.

The position and structure information of the target T, which is information on the position and structure of the target T included in the shooting training content output on the screen S, may include area information and the like such as a size, and the information on the area information and the like may be received from the content.

In addition, the point-of-impact generation module 170 may reflect the target T movement information on the movement of the target T and the impact time information in the point-of-impact information. That is, when the target T is generated, the point of impact may be corrected by the delayed time in consideration of the impact time according to the movement distance of the bullet B.

According to the point-of-impact analysis apparatus 100 having such a configuration, various elements occurring in the actual shooting environment such as the gun F, the bullet B, the environment, and the target T are equally applied to the virtual shooting training, thereby more improving the efficiency of the virtual shooting training.

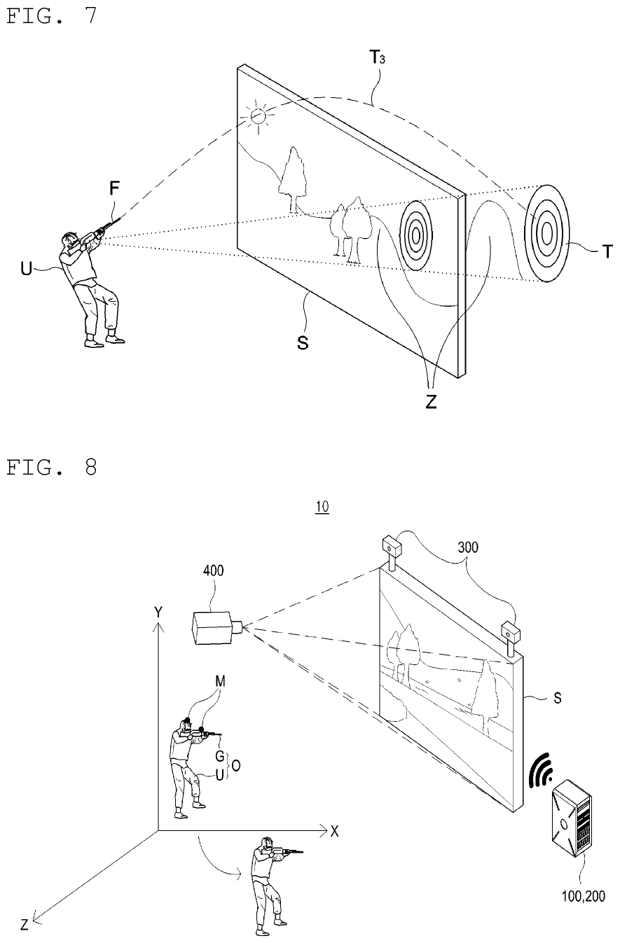

In the above description, the configuration and operation of the point-of-impact analysis apparatus 100 has been described. In FIG. 7, a howitzer moving method of the bullet will be described.

FIG. 7 is a diagram for explaining the howitzer moving method of the bullet according to the embodiment of the present invention.

As illustrated, according to the point-of-impact analysis apparatus 100 of the present invention, the virtual gun F may also be utilized as a howitzer.

The howitzer is a type of firearms that hit the target T by howitzing the obstacle when the target T is located behind an obstacle Z. Therefore, in the case of the howitzer, the bullet may be fired to be movable in a howitzer ballistic T3 which is a parabolic. Here, the obstacle Z may be represented in a plane on the screen S, and the point-of-impact analysis apparatus 100 may generate the point-of-impact information by applying a distance between the obstacles Z from the screen S on the shooting training content.

The existing shooting training simulation has a problem that it is difficult to implement the function of the howitzer as the bullet is fired in a linear line. In other words, as in the present invention, the existing technology does not reflect both the distance in the real space and the distance in the virtual space, and does not reflect the distance in the virtual space of the obstacle Z, and therefore there is a problem that the point of impact of the howitzer may not be accurately calculated.

On the other hand, the point-of-impact analysis apparatus 100 according to the present invention may collect muzzle angle information on the muzzle angle (through the vision detection module 140) when the virtual gun F is triggered. When the muzzle angle information is collected in this way, the point-of-impact information on the point of impact of the howitzer may be generated by referring to various element information and muzzle angle information of the above-described embodiments.

For example, the point-of-impact analysis apparatus 100 may generate the point-of-impact information by receiving the first bullet movement distance information which is the actual distance from the virtual gun F to the screen S in the real space and the second bullet movement distance information which is the virtual distance up to the target T on the shooting training content which is the virtual reality space displayed on the screen S and applying the combined distance of the first bullet movement distance and the second bullet movement distance as the bullet movement distance information D. At this time, the point-of-impact analysis apparatus 100 may generate the point-of-impact information by considering the first bullet movement distance information, the second bullet movement distance information, and the distance from the screen S to the obstacle Z on the shooting training content displayed on the screen S/the height of the obstacle Z, and the like. Accordingly, the point-of-impact analysis apparatus 100 of the present embodiment may determine whether the bullet hits the target T by considering the distance from the screen S to the obstacle Z/the height of the obstacle Z and the like on the shooting training content displayed on the screen S on the shooting training content.

The generated point-of-impact information may be reflected in the shooting training content to be output to the user U in real time on the screen S.

Accordingly, according to the point-of-impact analysis apparatus 100 of the present embodiment, not only the shooting training on a flatland but also the howitzer training for the obstacle Z may be performed in the same manner as the actual shooting, and thus the diversity of training may be further improved.

The point-of-impact analysis apparatus 100 that can perform the howitzer training has been described above.

Hereinafter, the virtual shooting training simulation system to which the point-of-impact analysis and the image correction reflecting the real space are applied will be described.

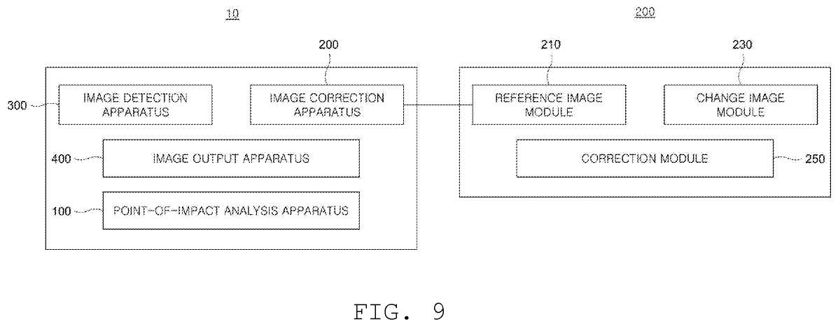

FIG. 8 is a conceptual diagram for explaining a method of using a virtual shooting training simulation system according to another embodiment of the present invention.

As illustrated, a virtual shooting training simulation system 10 configures the virtual shooting training simulation using the shooting training content, and may perform the image correction according to the user U and the position of the virtual gun G possessed by the user U along with the point-of-impact analysis apparatus described above in FIGS. 1 to 7. To this end, the simulation system may include the point-of-impact analysis apparatus 100, an image correction apparatus 200, an image detection apparatus 300, an image output apparatus 400, and the like.

The image detection apparatus 300 may be configured by a means such as a camera as a means for detecting position information of an object O such as the user U and a virtual gun G possessed by the user U in the real space. In this case, the image detection apparatus 300 may be configured by a plurality of cameras and may be coupled to an upper portion of the screen S to be described later. The image detection apparatus 300 may collect the image information of the object O, detect the position thereof, and generate the position information thereon.

Since the point-of-impact analysis apparatus 100 is constituted and operated as described above with reference to FIGS. 1 to 7, a further description thereof will be omitted.

The image correction apparatus 200 may be a means for correcting the image information output on the screen according to the change in the position of the object O. In other words, the image correction apparatus 200 may correct the image information (shooting training content) output on the screen S according to the position of the object O. A detailed configuration and operation method of the image correction apparatus will be described later with reference to FIG. 9.

The image detection apparatus 300 may generate position information by detecting a vision marker M attached to a user U's body, clothing, or the virtual gun G. The vision marker M may be composed of a plurality of colors, patterns, and the like, and the image detection apparatus 300 may be configured as an infrared camera capable of detecting the color, the pattern, or the like of the corresponding vision marker M.

In addition, although not specifically illustrated in the present embodiment, the vision marker M may be formed in a local area network tag or the like or may be formed in an infrared reflective structure, and the image detection apparatus 300 may be configured to correspond to the vision marker M.

In addition, when the object O is configured by a wearable terminal such as Google Glass, the image detection apparatus 300 may be implemented in a configuration capable of communicating with the corresponding terminal.

Here, the screen S, which is a means for outputting image information, may be a display unit capable of outputting an image itself or may receive and output an image irradiated in the form of a beam from the outside in a blind or roll structure. In the present embodiment, a fixed blind structure will be described as an example, but the present invention is not limited thereto, and a movable type, a variable type, a screen, a self-image output display unit, or the like may be applied.

The image output apparatus 400, which is a means for outputting an image toward the screen S, may be configured by a beam project. In addition, the image output apparatus 400 may be configured by a display unit integrally formed with the screen S.

In addition, the shooting training simulation system 10 may further include a communication unit, a user input unit, a memory unit, a control unit that is an integrated controller for controlling them as a whole, and the like.

According to such a shooting training simulation system 10, it is possible to output the image of the shooting training content corresponding to the viewpoint of the object O positioned in the real space by correcting the image information output on the screen S according to the position of the object O. In addition, it is possible to further improve the shooting training efficiency by applying variables similar to the actual shooting training at the time of shooting of the virtual gun G for the corresponding shooting training content.

The overall configuration of the shooting training simulation system (10) has been briefly described above. In FIG. 9, the configuration and operation method of the image correction apparatus will be described.

FIG. 9 is a block diagram for explaining a configuration of the image correction apparatus 200 included in the virtual shooting training simulation system of FIG. 8.

As illustrated, the image correction apparatus 200 may be an apparatus for correcting the image information of the shooting training simulation system 10 described above in FIG. 8.

The image correction apparatus 200 may include a reference image module 210, a change image module 230, and a correction module 250.

The reference image module 210 may generate reference image information, which is an image corresponding to the reference position information, when an object is positioned at a reference position in the real space and detected.

In other words, when the position of the object is positioned at the reference position when a specific area in a real space is set as a reference position, the reference image information in which coordinate information of the object and the coordinate information of a center point of an image are positioned on the same line at the reference position may be generated. Accordingly, when the reference image information is output, the object may match the center point of the image with a field of view.

When the object is moved from the reference position, the change image module 230 may detect change position information on the change position, which is a changed position, and generate the change image information corresponding thereto. At this time, the coordinate information of the center point of the change image information is positioned on the same line as the change coordinate information of the object in the same manner as the above-described reference image information, so the object may match the center point of the change image information with the field of view even at the change position.

The correction module 250 may generate correction information based on the reference position information and the change value of the change position information, and generate the correction image information in which the generated correction information is reflected in the change image information.

When the change image information is generated according to the change position, the distortion of the viewpoint may occur between the change position, which is the real space, and the change image information, which is the virtual space. Accordingly, the correction module 250 determines how much change has been made in the reference image information through the difference between the reference position information and the change position information, and reflects the determined change in the change image information, thereby minimizing the gap between the real space and the virtual space.

Specifically, when the object coordinate information, which is the coordinate value of the position of the object in the real space, is included in the position information, the correction module 250 may generate the reference coordinate information which is the coordinate value of the reference image information and the coordinate value of the change image information so as to correspond to the coordinate information of the object. In this case, when the object is positioned at the change position, the correction module 250 may generate the correction information so that the change coordinate information matches the reference coordinate information.

In addition, when the correction coordinate information, which is the coordinate information of the correction image information included in the correction information, is not included in the screen coordinate information that is the reference coordinate value of the screen, the correction module 250 may reset the screen information on the screen aspect ratio and generate the correction image information reflecting the reset screen information.

The image correction apparatus 200 as described above may generate not only the correction image information by matching the coordinate information of the object positioned in the real space with the coordinate information of the reference image/change image which is the virtual space, but also the correction image information by considering the screen aspect ratio, thereby minimizing the image distortion phenomenon due to the position movement of the object and the change in the viewpoint accordingly.

In the above, the configuration and operation principle of the image correction apparatus 200 has been described. Hereinafter, the overall operation method of the shooting training simulation system 10 including the image correction apparatus 200 will be sequentially described.

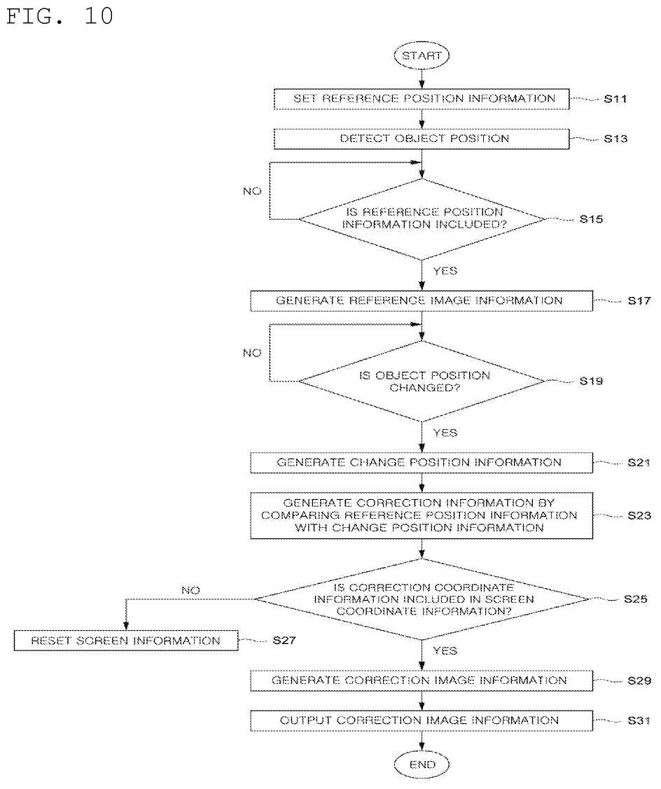

FIG. 10 is a flowchart illustrating a method of operating the virtual shooting training simulation system of FIG. 8, and FIGS. 11 to 15 are diagrams for explaining the operation method of FIG. 10 with images for each step. Since the words described in the present embodiment are the same as the words described above in FIGS. 8 and 9, reference numerals for the same component will be omitted. In addition, since the point-of-impact analysis apparatus has been described above with reference to FIGS. 1 to 7, a description of the components is omitted, but the information generated by the point-of-impact analysis apparatus may be corrected by the image correction apparatus.

The shooting training simulation system (not illustrated in FIGS. 8 and 10) is assumed to be configured as illustrated in FIG. 8 and describes the operation method thereof.

As illustrated in FIG. 3, the image correction apparatus of the initial shooting training simulation system may set the reference position information (S11).

As illustrated in FIG. 11, the reference position information may be setting information on matching the initial real space and the virtual space of the image correction apparatus.

Specifically, in the memory module (not illustrated), the screen coordinate information, which is the coordinate information on the entire screen S, may be generated, and the reference coordinate information, which is a coordinate value for a reference position W in the real space detected by the vision detection unit, may be stored in advance. The reference coordinate information may be coordinate information of an area where the vision detection unit detects the specific point in the real space, which may be input and set through the user input module (not illustrated).

A measurement apparatus J may generate a positional relationship from a current position to a corresponding specific point by irradiating a laser like a laser tracker.

Therefore, the measurement apparatus J is disposed at a measurement position which is a position in the real space, and when screen temporary coordinate information (A1, A2, A3, A4, and A5) on the plurality of coordinates which is spaced apart from each other in the internal area of the screen S is input, the laser is irradiated toward the corresponding screen temporary coordinate information, and measurement/screen position information, which is a positional relationship between the measurement position and the screen temporary coordinate information, may be calculated. In FIG. 4, five pieces of coordinate information are input as the screen temporary coordinate information, but the number of coordinates is not limited, and a plurality of different coordinate information may be included regardless of the number of coordinates.

The measurement/screen position information may include comprehensive positional relationship information related to distance information, direction information, angle information, and the like of a measurement position for each coordinate of the screen temporary coordinate information.

When the measurement/screen position information is calculated in this way, the measurement apparatus J may measure the above-described reference position and generate measurement/reference position information regarding a positional relationship between the measurement position and the reference coordinate information which is a reference position.

The measurement apparatus J may transmit the generated measurement/screen position information and measurement/reference position information to the image correction apparatus (reference image module).

The image correction apparatus (reference image module) may match the received measurement/screen position information with the screen reference coordinate information corresponding to the circumferential area of the screen 120 to generate first reference relationship information on the correlation therebetween. In addition, the image correction apparatus (reference image module) may refer to the received measurement/screen position information and the measurement/reference position information to generate second reference relationship information on the correlation therebetween. Thereafter, the image correction apparatus (reference image module) may generate third reference relationship information regarding the correlation between the measurement/reference position information and the screen reference coordinate information by referring to the first reference relationship information and the second reference relationship information.

Accordingly, as the image correction apparatus (reference image module) generates the third reference relationship information, when the screen of the first image correction apparatus is configured, the real space and the virtual space may be matched according to the third reference relationship information to more definitely set the positional relationship thereof.

When the reference position information on the initial screen of the image correction apparatus is set, the position information of the object O may be detected by the image detection apparatus (S13).

When the object O is positioned at a preset reference position L1 (a position facing the screen S and spaced by a certain distance in the resent embodiment) in the real space equipped with the screen S, the image detection apparatus detects the position information of the object O, and the image correction apparatus may determine whether to include reference position L1 information stored in the memory unit (S15). At this time, the image correction apparatus (reference image module) sets the position information of the object O as the first reference coordinate information, and reflects the third reference relationship information in the first reference coordinate information, so the position information of the object O may be converted into the reference position information. Accordingly, even if the object O is not positioned at a preset reference position, the position where the object O is positioned may be automatically set as the reference position.

The position information of the object O may be calculated by converting the real space into the coordinate information, and comparing the coordinate information of the object O among the corresponding coordinate information. In particular, since the image needs to change with respect to the viewpoint of the object O, a means for determining the position of the object O can recognize a part related to an eye of the object O as a position target.

For example, the vision marker may be attached to an area similar to a user's eye, and the image detection apparatus may detect position information by detecting the corresponding vision marker. In addition, when the image detection apparatus is configured as an image recognition means, the eye of the object O among the recognized image information may be set as a reference point for the position information. In addition, when the vision marker is attached to the virtual gun, the virtual gun may be set as a reference point.

Further, although not specifically illustrated in the present embodiment, the reference position L1 may be set according to an input signal while the object O is positioned in the real space. In other words, when the object O is positioned in the real space and the reference position L1 input signal is received, the control unit may set current position information of the object O as the reference position L1 information.

When the position information of the object O includes the reference position L1 information, the image correction apparatus may generate reference image information SP which is the image corresponding to the reference position L1 information (S17).

The reference image information SP may be an image which has the coordinate information of the object O which is real space coordinate information of the object O, and center coordinate information positioned on the same line as the coordinate information of the object O. In other words, the reference image information SP may be an image obtained by adjusting the center coordinate information of the content image output by the object O to the same line as the coordinate information of the object O. Since the coordinate information of the object O is an area coordinate corresponding to the same viewpoint as the eye of object O, when the coordinate and the center point coordinate information C of the reference image information SP are positioned on the same line, the object O may receive an image that is output from its viewpoint.

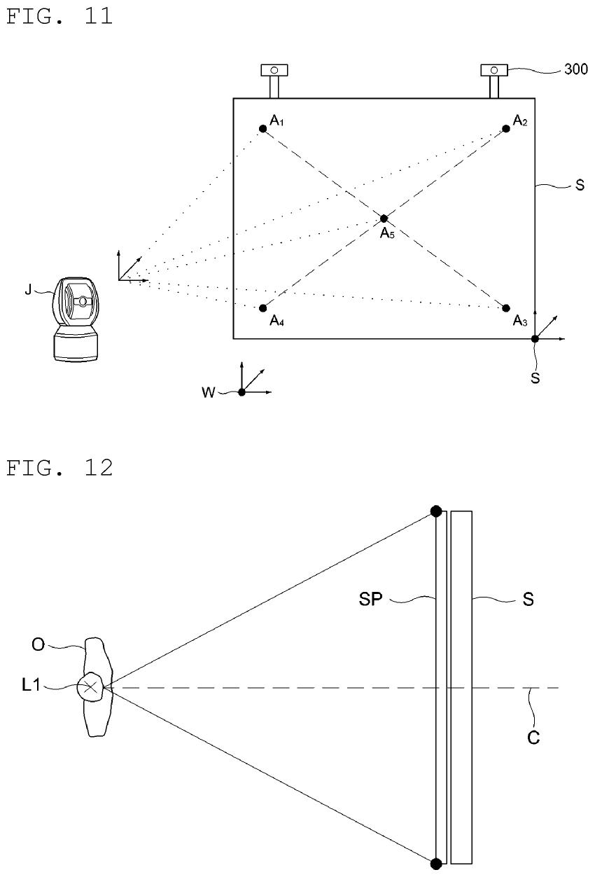

In FIG. 12, the reference image information SP and the screen S are separately illustrated for convenience of explanation, but in reality, the reference image information SP may be integrated and displayed on the screen S.

Thereafter, the image correction apparatus may determine whether the object O is changed at the reference position L1 (S19). This may be determined as whether the position information of the object O detected by the image detection apparatus includes the change position L2 information moved from the reference position L1 to a different change position L2. In other words, it is possible to determine whether the position of the object O changes based on whether the coordinate information of the object O in the real space changes.

When the object O is moved from the reference position L1 to the change position L2, the image correction apparatus may generate the change image information CP that is an image corresponding to the change position L2 information (S21).

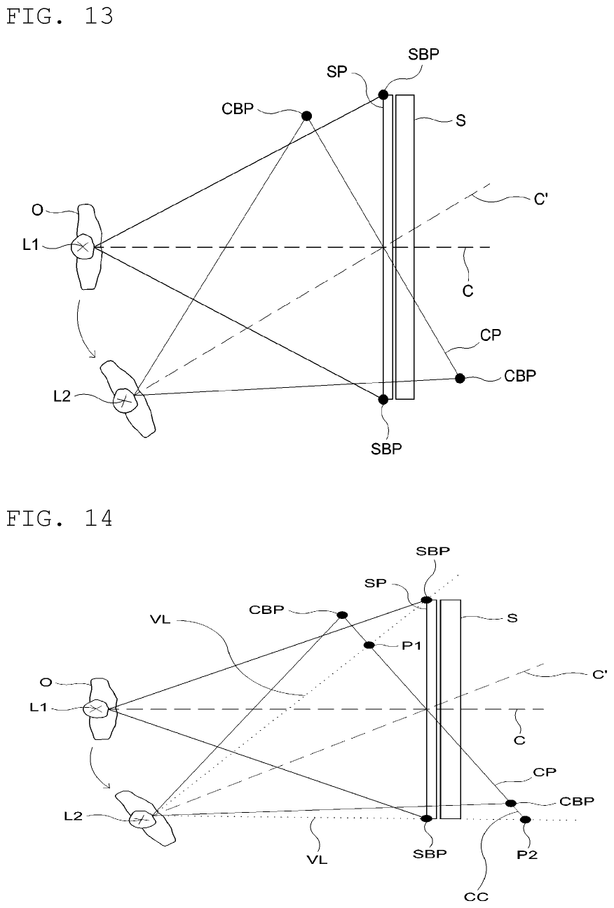

The change image information CP is substantially the same as the reference image information SP, but differs in that the position information of the object O is changed from the reference position L1 to the change position L2. Therefore, as illustrated in FIG. 13, the change image information CP may be image information that has the coordinate information of the object O at the change position L2 of the object O and coordinate information of a center coordinate point C′ positioned on the same line as the coordinate information of the object O. Accordingly, the object O may receive the change image information CP output from its own viewpoint at the change position L2.

In this way, the object O may receive an image corresponding to a change in its position, but in the case of the change image information CP, a distortion phenomenon may occur according to a viewpoint. In other words, the screen S may be implemented with a function such as a window that is positioned between the real space and the virtual space in order to implement an area where the actual image is output or a more realistic virtual space. Therefore, when the image direction is simply changed according to the position of the object O, a difference from the viewpoint of the object O may occur. Therefore, when the position of the object O is moved, it is necessary to generate and reflect correction information that may match the reference image information SP at the moved change position L2.

To this end, the image correction apparatus may compare the reference position L1 information with the change position L2 information and generate correction information that is a result of the comparison (S23). The correction information may be a value for matching the change coordinate information, which is a coordinate value of the change image information CP at the change position L2, with the reference coordinate information that is the coordinate value of the reference image information SP.

As illustrated in FIG. 14, the reference coordinate information may include reference circumferential coordinate information SBP corresponding to the circumference of the screen 120 in the reference image information SP, and the change image information CP may include each of change circumference coordinate information CBP corresponding to the circumference of the screen S in the change image information CP.

At this time, the image correction apparatus may generate reference line information on virtual lines connected to each of the reference circumferential coordinate information SBP in a linear line at the change position L2, and may generate cross coordinate information P1 and P2 on intersections of a reference line information and the change coordinate information of the change image information CP.

It is possible to generate change extension coordinate information CC in which the change coordinate information extends in a linear direction and generate the cross coordinate information P1 and P2 by comparing the generated change extension coordinate information CC with the reference line information.

In FIG. 13, the system viewed from top to bottom is illustrated, and each circumferential coordinate information is presented only to correspond to both ends of a width of the screen S width, but is not limited thereto, and coordinate values corresponding to the width and height of the image corresponding to left, right, top, and bottom positions of the object O may be calculated.

When the cross coordinate information P1 and P2 is calculated in this way, the image correction apparatus may generate first correction coordinate information corrected by Equation 4 below in order to match the cross coordinate information P1 and P2 with the reference image information SP.

$$First correction coordinate information ( U , V ) \\ U = \frac{\frac{{w}_{1}}{2} + x * {w}_{2}}{{w}_{1}} , V = \frac{\frac{{h}_{1}}{2} + y * {h}_{2}}{{h}_{1}} \qquad [ Equation 4 ]$$

(U: X value of first correction coordinate information, V: Y value of first correction coordinate information, W₁: width of reference image information, X: X value of cross coordinate information, W₂: width of change image information, h₁: height of reference image information, Y: Y value of cross coordinate information, h₂: height of change image information)

The first correction coordinate information may attenuate distortion that occurs when the object O looks at the screen S at the change position L2 by matching the cross coordinate information P1 and P2 with the existing image information.

When the correction information is generated in this way, the image correction apparatus may determine whether the corresponding correction coordinate information is included in the screen coordinate information (S25).

The screen coordinate information may be a reference coordinate value for the height and width of the screen S. Accordingly, the images output to the screen S may be generated to correspond to the screen coordinate information. Accordingly, when the first correction coordinate information is included in the screen coordinate information, the image correction apparatus may generate the correction image information in which the first correction coordinate information is reflected in the change image information CP (S29).

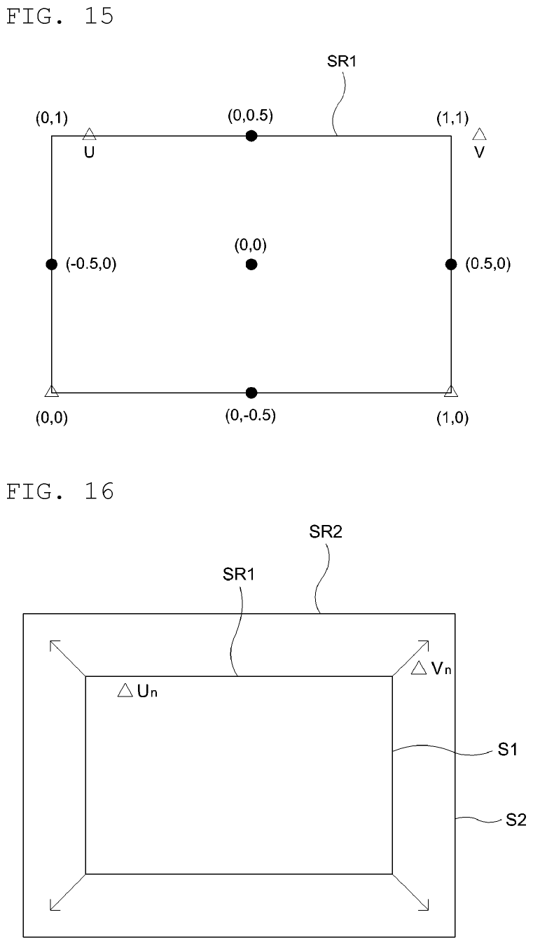

On the other hand, there may be a case where the first correction coordinate information is not included in the screen coordinate information. As illustrated in FIG. 15, this may be a case where the first correction coordinate information generated by the Equation 3 deviates from the screen coordinate information.

In this case, in order to include the first correction coordinate information in the screen coordinate information, the screen information regarding the screen S aspect ratio may be reset (S27). This may be implemented by Equation 5 below.

$$second correction coordinate information ( {U}_{n} , {V}_{n} ) \\ {U}_{n} = 0.5 - \frac{0.5 - U}{r} , {V}_{n} = 0.5 - \frac{0.5 - V}{r} \qquad [ Equation 5 ]$$

(Uₙ: X value of the second correction coordinate information, Vₙ: Y value of the second correction coordinate information, U: X value of the first correction coordinate information, V: Y value of first correction coordinate information, r screen increase ratio)

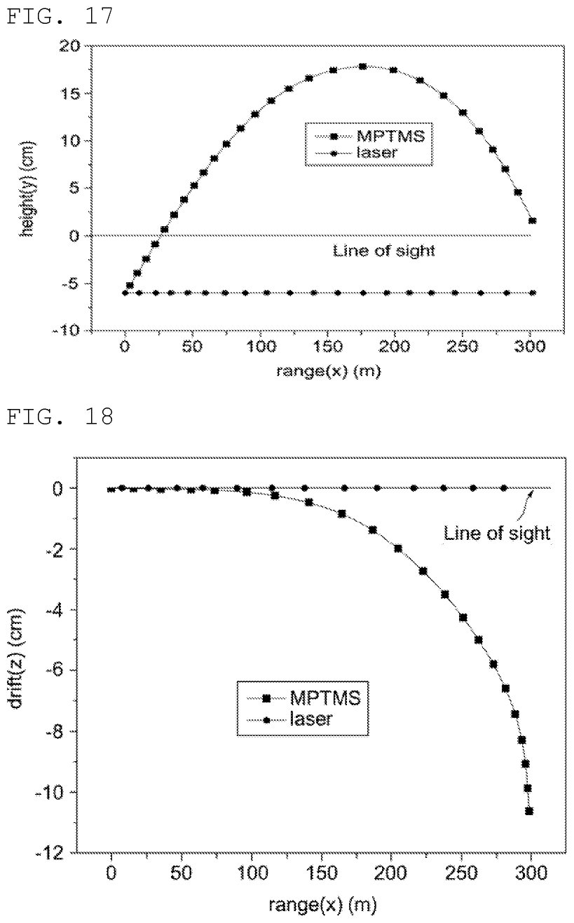

According to the reset screen information, the first correction coordinate information may not be included in the existing screen information SR1, and therefore may include extended screen information SR2 extending the screen information SR1. Accordingly, as illustrated in FIG. 16, the screen coordinate information may be extended to include the first correction coordinate information, and the first correction coordinate information may be converted into the second correction coordinate information reset to correspond to the extended screen information SR2.

When other second correction coordinate information is calculated upon resetting the screen information, the image correction apparatus may control to generate the correction image information in which the calculated second correction coordinate information is reflected in the change image information CP, generate the correction image information reflecting the generated correction image information (S29), and output the generated correction image information to the image output apparatus to be displayed on the screen S (S31).

According to the shooting training simulation system having such an image correction apparatus, the image may be changed in real time to correspond to the field of view according to the change in the position of the object 0, and the coordinates of the corrected image may be set in consideration of the screen aspect ratio, thereby minimizing the distortion phenomenon of the image due to the change in the viewpoint of the object O. In addition, by generating and applying the point-of-impact information reflecting the actual shooting environment by the point-of-impact analysis apparatus, it is possible to implement the virtual shooting training simulation in the environment similar to the actual shooting training in the real space.

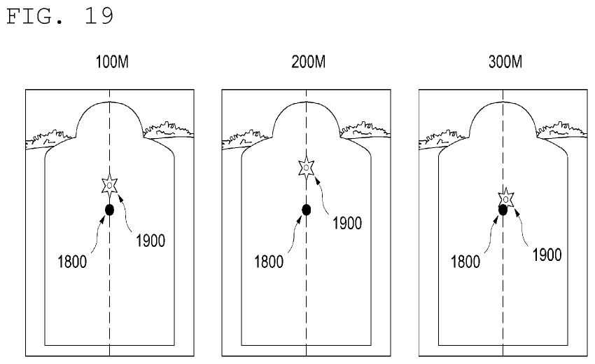

FIGS. 17 and 18 are diagrams for explaining a method of deriving a ballistic trajectory according to an embodiment of the present invention.

FIG. 17 is a diagram illustrating a trajectory derived by the point-of-impact analysis apparatus 100 based on an X axis (linear distance: range) and a Y axis (height), and FIG. 18 is a diagram illustrating a trajectory derived by the point-of-impact analysis apparatus 100 based on the X axis (linear distance: range) and a Z axis (drift).

Referring to FIGS. 1, 2, and 17, the point-of-impact analysis apparatus 100 may derive a ballistic trajectory using Equation 6.

$$\frac{d \vec{V}}{dt} = - \frac{1}{2 m} ρ {SC}_{{D}_{0}} V \vec{ V} + \frac{1}{2 m} ρ {SC}_{{L}_{0}} {\vec{α}}_{T} + \vec{g} \qquad [ Equation 6 ]$$

Where m: warhead mass, S: warhead cross sectional area, ρ: air density, \vec{g}: gravitational acceleration, C [symbol] : linear drag coefficient, C_{L}_{₀}: linear lift coefficient, α_{T}: total angle of attack, V: warhead velocity (v=\sqrt{vₓ²+v_{y}¹+v_{z}²})

\vec{V}=Vₓ\hat{x}+V_{y}ŷ+V_{z}\hat{z}(\hat{x}:x axis unit vector, ŷ:y axis unit vector, \hat{z}:z axis unit vec

Referring to FIG. 17, the existing laser method applies a ballistic trajectory (laser graph in FIG. 17) without discriminating between gravity, lift, drag, rotation, etc., acting on a bullet flying in the air, and applies the linear ballistic trajectory regardless a shooting range. On the other hand, the present invention may reflect gravity, lift, drag, rotation, and the like acting on the bullet as in Equation 6, thereby deriving the ballistic trajectory (MPTMS graph in FIG. 17) reflecting the height (Y axis) and drift (Z axis) varying depending on the shooting range (X axis). Here, the line of sight is based on a shooter's line of sight (“0 cm based on a Y-axis”), and point 0 on the X axis is a muzzle's aiming direction (“about −6 cm based on the Y axis”).

For example, in the existing laser method, at a point where the shooting range is 100 m, a point where a height is about −6 cm and the drift is zero is a point of impact, but in the method according to the present invention, a point where a height is about +10 cm and the drift is about −1 cm becomes the point of impact.

For example, in the existing laser method, at a point where the shooting range is 200 m, a point where a height is of about −6 cm and the drift is zero is a point of impact, but in the method according to the present invention, a point where a height is about +17 cm and the drift is about −2 cm becomes the point of impact.

As such, the method according to the present invention reflects that the point of impact varies as the height (X axis)/drift (Z axis) of the point of impact varies according to the position of the shooting range, so the point of impact may be derived similar to the actual ballistic trajectory.

FIG. 19 is a diagram for explaining a point of impact changed according to the ballistic trajectory according to the embodiment of the present invention.

Referring to FIG. 19, the point of impact on the target according to the existing laser method and the method according to the present invention is illustrated, and when the target is 100 m/200 m/300 m, the existing laser method does not change the point of impact 1800 according to the distance at all.

On the other hand, when the target is 100 m/200 m/300 m, the method according to the present invention is that there is a change in the point of impact 1900 according to the distance.

Therefore, the existing laser method constantly reflects the point of impact regardless of the distance, and therefore recognizes that it hits the center of the target, but the method according to the present invention may accurately derive whether it does not hit the center of the target, how many centimeters it deviates from the center of the target, or the like. Accordingly, the method according to the present invention may derive the point of impact very similar to the actual ballistic trajectory.

The point-of-impact analysis apparatus for improving the accuracy of the ballistic trajectory and the point of impact by applying the shooting environment of the real personal firearm to the virtual reality, and the virtual shooting training simulation using the same are not limited to the configuration and operating method of the above-described embodiments. The above-mentioned embodiments may be configured so that various modifications may be made by selective combinations of all or some of the respective embodiments.

1. A point-of-impact analysis apparatus for improving accuracy of a ballistic trajectory and a point of impact by applying shooting environment of a real personal firearm in virtual reality, the point-of-impact analysis apparatus comprising:
a gun analysis module for generating gun information on a gun structure of a virtual gun which is a model possessed by a user in a real space;
a bullet analysis module for generating bullet information on a structure of a bullet applied to the virtual gun;
an environment analysis module for detecting an environmental state of a shooting training content output on a screen so as to generate environmental information on the environmental state; and
a point-of-impact generation module for generating point-of-impact information related to a position, at which the bullet impacts a target displayed on a screen, by making reference to at least one piece of information among the gun information, the bullet information, and the environmental information.

2. The point-of-impact analysis apparatus of claim 1, wherein the gun information includes gun type information, gunbarrel length information, and gun stiffness information, and
the bullet information includes bullet type information, bullet mass information, bullet appearance information, and bullet pressure center information.

3. The point-of-impact analysis apparatus of claim 2, wherein the point-of-impact generation module generates first bullet movement information related to movement information on the bullet in the virtual gun by referring to the gun information and the bullet information.

4. The point-of-impact analysis apparatus of claim 3, wherein the first bullet movement information is calculated by Equations 1 and 2 below.
K=½mv²+½IW² [Equation 1]
(K: first bullet movement information, m: bullet weight, v: bullet speed I: inertial moment, ω: bullet rotational angular velocity)
I=∫₀^{R}r²dm [Equation 2]
(dm: fine particle mass, γ: linear length from rotation center axis to fine mass, R: maximum linear length of object from rotation center axis)

5. The point-of-impact analysis apparatus of claim 4, wherein the environment information includes air temperature information, density information, pressure information, wind direction information, wind speed information, and gravitational information included in the shooting training content.

6. The point-of-impact analysis apparatus of claim 5, wherein the point-of-impact generation module generates second bullet movement information related to movement information of the bullet that is moved between the virtual gun and the target by referring to the first bullet movement information and the environmental information.

7. The point-of-impact analysis apparatus of claim 6, wherein the second bullet movement information is calculated by Equation 3 below.
[Equation 3]
Second bullet movement information(aₓ, a_{y})
I=∫₀^{R}r²dm
(aₓ: force acting on X axis of bullet, a_{y}: force acting on Y axis of bullet, C_{D}: drag coefficient, ρ: air density, d:
bullet diameter, V: bullet speed in air, g: acceleration of gravity)

8. The point-of-impact analysis apparatus of claim 7, wherein the point-of-impact generation module generates the point-of-impact information by referring to the first bullet movement information and the second bullet movement information, and target information on a position and a structure of the target.

9. The point-of-impact analysis apparatus of claim 8, further comprising:
a time analysis module for generating impact time information on time required for the bullet to be moved from the virtual gun to the target,
wherein the point-of-impact generation module generates the point-of-impact information by referring to the impact time information.

10. The point-of-impact analysis apparatus of claim 9, wherein the point-of-impact generation module generates the point-of-impact information by referring to the impact time information.

11. A virtual shooting training simulation system for image correction reflecting a real space and improvement in accuracy of a point of impact, the virtual shooting training simulation system comprising:
an image detection apparatus for generating object image information, which is image information obtained by detecting a user and a virtual gun which is a model possessed by the user, based on a screen on which shooting training content is output in a real space;
an image correction apparatus for comparing reference image information detected at a reference position by analyzing the object image information and change image information detected at a change position, which is a position changed from the reference position, to generate correction information as a result value thereof, and for generating correction image information in which the correction information is reflected in the change image information; and
a point-of-impact analysis apparatus for generating point-of-impact information on a position at which the bullet impacts a target displayed on the screen by referring to gun information on a structure of the virtual gun, bullet information on a structure of a bullet applied to the virtual gun, and environmental information on an environmental state of the shooting training content.
